(19) United States
(12) Patent Application Publication
(10) Pub. No.: US 2026/0287037 A1
(43) Pub. Date: Sep. 24, 2026

(54) Energy Absorption Member with a Cone-Structure

(71) Applicant: Zephyros, Inc., Romeo, MI (US)

(72) Inventors: Nuria Ignes I Mullol, Molsheim Cedex (FR); Amar Ali-Larnene, Molsheim Cedex (FR)

(21) Appl. No.: 19/472,518

(22) PCT Filed: Apr. 4, 2024
(86) PCT No.: PCT/EP2024/059198

§ 371 Date: Oct. 3, 2025

(30) Foreign Application Priority Data
Apr. 11, 2023 (EP) 23167410.2
Nov. 14, 2023 (EP) 23209756.8

(51) Int. Cl. F16F 7/12; B62D 21/15

(52) U.S. Cl. CPC F16F 7/12; B62D 21/157

(57) ABSTRACT

The present invention relates to a member to absorb energy, particularly impact-energy. The present invention further relates to a structure comprising the member and a method to absorb energy, particularly impact energy.

The present invention relates to a member to absorb energy, particularly impact-energy. The present invention further relates to a structure comprising the member and a method to absorb energy, particularly impact energy.

There is a constant need in the industry, particularly in the automotive industry, to provide members which absorb energy, particularly impact energy, in order to protect the passengers and certain elements of a vehicle and/or a structure.

The problem is attained with a member to absorb energy, particularly impact-energy, comprising at least a first layer and a second layer, each layer comprising a multitude of interconnected three-dimensional elements, wherein the three-dimensional elements of the first layer are inserted into the three-dimensional elements of the second layer and/or vice versa and wherein the sidewall of the three-dimensional element of at least one layer has a varying thickness along the largest extension of the three-dimensional elements, preferably its height.

The disclosure regarding this subject matter also applies to the other subject matters and vice versa. Subject matters disclosed regarding this embodiment of the invention can also be included in other embodiments and vice versa.

The present invention relates to a member to absorb energy, particularly impact-energy. The member comprises at least a first layer and a second layer, each layer comprising a multitude of interconnected three-dimensional elements.

Preferably, the three-dimensional elements are hollow elements. The three-dimensional elements have a sidewall that extends from a base to a top of the three-dimensional elements. The three-dimensional elements preferably have a circular, an oval and/or a polygonal cross-section. Each three-dimensional element is preferably a truncated cone. The shape of the cross section of the three-dimensional element may vary with its axial extension. The axial extension is preferably the largest extension of the three-dimensional element. One layer may have three-dimensional elements with different cross sections and/or different axial lengths. Preferably, the three-dimensional elements are tapered, preferably with a larger or the largest cross section in the plane in which the three-dimensional elements are interconnected, preferably by a layer that extends between the circumference of two adjacent three-dimensional elements, preferably at the base of the three-dimensional elements. Additionally or alternatively, two adjacent three-dimensional elements of one layer can be directly connected at their base. In case the three-dimensional elements are tapered, the angel of inclination may be constant around their entire circumference or not. The angel of inclination may further vary with the axial length of the three-dimensional element. The sidewall of the one or more three-dimensional element(s) of one layer may include one or more step(s) and/or shoulders. In case the sidewall is made of a laminate, not all layers of the laminate need to comprise the step(s).

Preferably the shape and/or the size of the cross-section of the three-dimensional elements of one or both layers vary with its axial extension and/or preferably the angle of inclination of the sidewall of the three-dimensional elements of one or both layers vary with its axial extension.

According to the invention the sidewall of the three-dimensional element of at least one layer has a varying thickness along the largest extension of the three-dimensional elements, preferably its height. Preferably, the three-dimensional elements of one layer have the largest sidewall thickness at the bottom and/or in the vicinity of the base, while the three dimensional elements of the other layer have its largest wall thickness at their top.

Each layer is preferably made from a polymeric material, more preferably nylon. The polymeric material has to be chosen such that sufficient energy absorption is assured in a temperature range between −20 to 50° C. range. Each layer is preferably produced individually. The layer is preferably produced by molding and7or injection modling.

The member comprises at least a first and a second layer. However, the member may comprise more than two layers, particularly three, four, five, six or seven layers.

Each layer comprises a multitude of interconnected three-dimensional elements. According to the invention. The three-dimensional elements of one layer are inserted into the three-dimensional elements of the adjacent layer. One end of each three-dimensional elements may be provided in a plane and the rest of each three-dimensional elements extends out of this plane. The three-dimensional elements are preferably hollow structures. The skilled person understands, that the plane need not be flat, but can be three-dimensional, for example curved. In this plane the three-dimensional elements of one layer are preferably interconnected, preferably according to a constant matrix, for example a Y x X matrix. Y is preferably 1-10. X is preferably 2-100.

The three dimensional elements of two adjacent layers are preferably different in the shape. The three-dimensional elements or one layer are inserted into the three-dimensional elements of the adjacent layer, preferably such that prior to an impact their tops and/or their bases are at least in close proximity to each other, preferably are in contact with each other. Preferably, prior to an impact, the sidewalls of two three-dimensional elements which are inserted into each other do not touch.

According to a preferred embodiment of the present invention, the sidewall of three-dimensional elements of at least one layer has an area of larger wall thickness and an area of smaller wall thickness. These areas preferably extend around the entire circumference of each three-dimensional element. Preferably, the area of larger wall thickness of the three-dimensional elements of one layer is directly adjacent to the area of smaller wall thickness of the three-dimensional elements of the adjacent layer.

Preferably, the areas of different wall thicknesses in the three-dimensional element of one layer are separated by a shoulder or an undercut. In case two three dimensional elements are inserted into each other and each has a shoulder or an undercut, the shoulders/undercuts of the two elements are preferably directly adjacent to each other or are in touch with each other.

Preferably, the three-dimensional elements of each layer are connected by a connecting layer and/or by contacting each other. Preferably in one layer the three-dimensional elements are connected by a connecting layer. Preferably this is the layer, whose three-dimensional elements, the so-called “male-elements” are inserted into the hollow three-dimensional elements of the adjacent layer, the so-called “female-elements”. The connecting layer is preferably flexible, so that this layer is bendable, preferably under its own weight if held at one. In the adjacent layer, the female elements are preferably connected directly, preferably at their and/or along a longer section of their circumference, preferably along their entire height. It is even possible that two adjacent three-dimensional elements have locally a common sidewall. This layer with the female three-dimensional elements is preferably less flexible than the layer with the male three-dimensional elements. Two female three-dimensional elements may be connected by a rib, which even more preferably extends over the entire height of the three dimensional element.

According to another inventive or preferred embodiment of the present invention, one layer, preferably the layer with the male three-dimensional elements, preferably the area between two adjacent three-dimensional elements is bendable and/or flexible, preferably bendable under the own weight of the layer if held at one end.

The disclosure regarding this subject matter also applies to the other subject matters and vice versa. Subject matters disclosed regarding this embodiment of the invention can also be included in other embodiments and vice versa.

Due to this flexibility, it is possible to insert the male three-dimensional elements into the female three-dimensional elements, even it the member is large and/or the three-dimensional elements are long in their largest extension.

Preferably, the layer can be bent in around two axis which are orthogonal relative to each other.

Two adjacent three-dimensional elements are preferably connected by a layer. This layer is preferably provided at the base of the three-dimensional elements and is preferably made of the same material as the three-dimensional elements themselves. The layer is preferably thin and/or comprises recesses to achieve the flexibility between of this layer.

One layer of the member, preferably the layer with the female three-dimensional element, is preferably stiffer than the bendable layer. This can be achieved with one or more rib(s) that connect(s) two adjacent three-dimensional elements. Alternatively or additionally, two adjacent three-dimensional elements are directly connect, for example by touching sidewalls and/or a common sidewall. The connection between the sidewalls of two adjacent three-dimensional elements can only be provided at the bottom but can also extend along a lager section of the sidewall, preferably along the entire height of three-dimensional element from the base to the top.

Another inventive or preferred embodiment of the present invention is a member to absorb energy, particularly impact-energy, comprising at least a first layer and a second layer, each layer comprising a multitude of interconnected three-dimensional elements, wherein the three-dimensional elements of the first layer are inserted into the three-dimensional elements of the second layer and/or vice versa.

The disclosure regarding this subject matter also applies to the other subject matters and vice versa. Subject matters disclosed regarding this embodiment of the invention can also be included in other embodiments and vice versa.

According to this embodiment, the layers are connected by connection means, preferably at the top and/or at the base of the three-dimensional elements, preferably by clips and/or by an adhesive.

This embodiment of the present invention reduces oscillation of the layers, particularly in their resonance frequency. This in turn reduces destruction and/or fatigue of the member.

Preferably, the three-dimensional elements of at least one, preferably both layers have an opening at their top and/or in the connection layer between two adjacent three-dimensional elements. This embodiments for example improves moulding of the layer and/or the flow of a coating material through the member.

Preferably or inventively, three-dimensional elements of at least one layer are a hollow truncated cone. Preferably, the three-dimensional elements of both layers are truncated cones. Preferably, the cross section of the truncated cone is polygonal, for example a quadrangle and/or a hexagon. The shape of the cross sections of the three-dimensional elements of at least one of the the two layers may change along the height of the three-dimensional element, for example differ between the base and the top of three-dimensional elements.

Another preferred or inventive embodiment of the present invention is a member to absorb energy, particularly impact-energy, comprising at least a first layer and a second layer, each layer comprising a multitude of interconnected three-dimensional elements, wherein the three-dimensional elements of the first layer are inserted into the three-dimensional elements of the second layer and/or vice versa.

According to this embodiment, prior to an impact, the two layers are locally in contact to each other.

The disclosure regarding this subject matter also applies to the other subject matters and vice versa. Subject matters disclosed regarding this embodiment of the invention can also be included in other embodiments and vice versa.

Contrary to the state of the art, the three-dimensional of one layer are right from the start and prior to an impact inserted, preferably entirely inserted into the three-dimensional elements of the adjacent layer. Preferably, the three-dimensional elements touch or are almost in touching contact at their top and/or their base prior to an impact.

The member may comprise a metal structure, preferably a hollow metal structure, more preferably a hollow beam, even more preferably a hollow beam with one or more ribs. The layers with the three-dimensional members are attached to the metal structure, preferably glued. During an impact, the metal structure is the last part that deforms. The metal structure is preferably not part of the structure of a vehicle but the member is preferably inserted into the structure of the vehicle. The metal structure is preferably an extruded or pultruded part. Preferably the metal structure is made from aluminum.

Preferably at least one of the first or second layer comprises connecting means. Via these connecting means, for example an adhesive layer, the layer can be connected to a structure, for example the structure of a vehicle and/or two or more layers can be connected by connection means, preferably an adhesive layer.

Each adhesive layer is preferably applied after the three-dimensional layer has been formed or the adhesive layer is part of the material of three-dimensional layer, for example an adhesive layer.

Two layers can also be connected to each other by connection means prior to an impact or an energy absorption. These connection means can be for example an adhesive, e.g. an adhesive layer, a friction-form-and/or fore-fit, for example a snap-fit.

Preferably, the three-dimensional elements of at least one layer comprise a reinforcement element. This reinforcement element, for example one or more rib(s) and/or a foam-layer, preferably structural-foam, is preferably provided in the hollow section of the three-dimensional element and/or between the three-dimensional elements. The reinforcement elements can be provided within the structure of the three-dimensional elements and/or adjacent to the three-dimensional elements.

Each layer of the member can be moulded as one single part. Other methods to produce the layers are, for example, pultrusion, injection molding and/or thermoforming and/or compression molding, and/or blow moulding.

Another subject matter of the present invention is a system comprising a structure and the inventive member.

The disclosure regarding this subject matter also applies to the other subject matters and vice versa. Subject matters disclosed regarding this embodiment of the invention can also be included in other embodiments and vice versa.

The structure can be any structure for example a crash barrier or a body armour or a vehicle The structure may be a metal- and/or a plastic-structure. The inventive member is provided at or in the structure to reduce its deformation for example during an impact. Preferably, the structure comprises a cavity in which the member is located. More preferably, at least one layer of the member is attached to the structure. Additionally or alternatively, the inventive member can be provided at a structure without a cavity.

The problem is also solved with a method to absorb energy, particularly impact energy, with, the inventive member, wherein different areas of the sidewall of the three-dimensional elements collapse, at least temporarily, sequentially.

The disclosure regarding this subject matter also applies to the other subject matters and vice versa. Subject matters disclosed regarding this embodiment of the invention can also be included in other embodiments and vice versa.

According to this subject matter of the present invention the two layers and their three-dimensional elements are provided such that they collapse sequentially. For example, the three-dimensional elements of one or both layers comprise areas of different wall thickness. The areas with less wall thickness of the sidewall of the three-dimensional elements will collapse first, while other areas of the three-dimensional elements stay intact and preferably collapse at a later stage.

Preferably, the three-dimensional elements are irreversibly expanded and/or irreversibly compressed and/or irreversibly tangentially stressed. More preferably, the three-dimensional elements of the first layer are irreversibly compressed in their cross-section and optionally in their axial extension, while the three-dimensional elements of the second layer are reversibly irreversibly increased in their cross-section and optionally reversibly and/or irreversibly widened and/or compressed in their axial extension.

The three-dimensional elements of the first layer are inserted into the three-dimensional elements of the second layer, preferably to an extend, that the top and/or of the three-dimensional elements of both layer are proximate or even touch.

Preferably, the three dimensional elements of two layers interlock during their plastic deformation.

In the following the inventions are explained according to the figures. These explanations do not limit the scope of protection. The explanations apply to all embodiments of the present invention likewise.

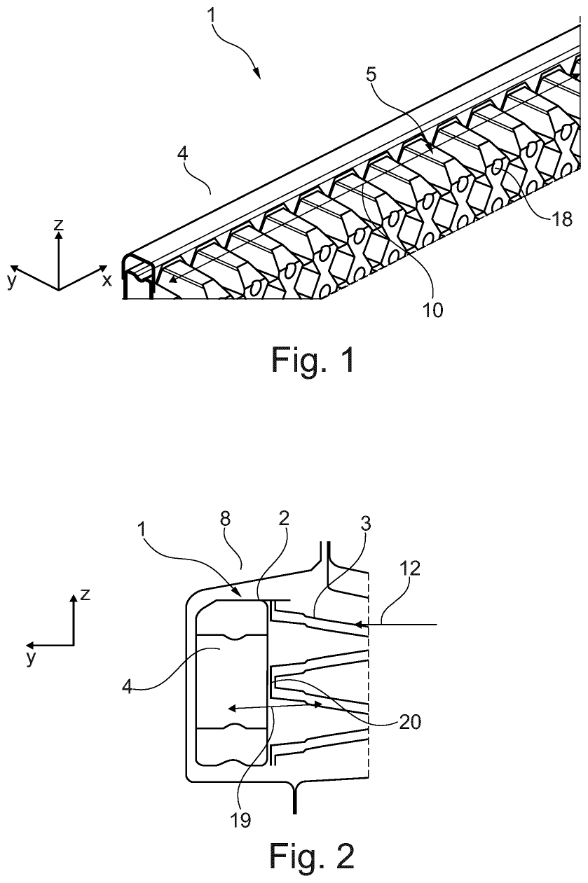

FIG. 1 shows an embodiment of the inventive member.

FIG. 2 the Inventive System.

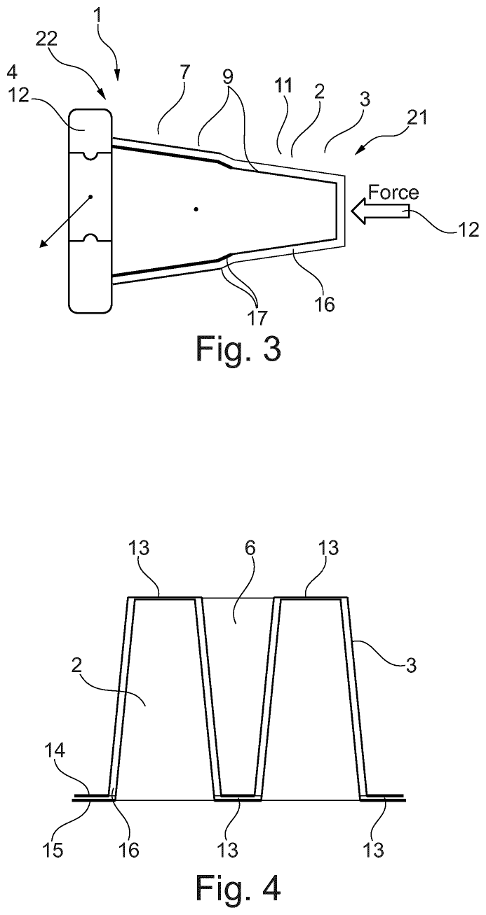

FIG. 3 shows details of the inventive member according to FIG. 1.

FIG. 4 shows the two layers of the inventive member.

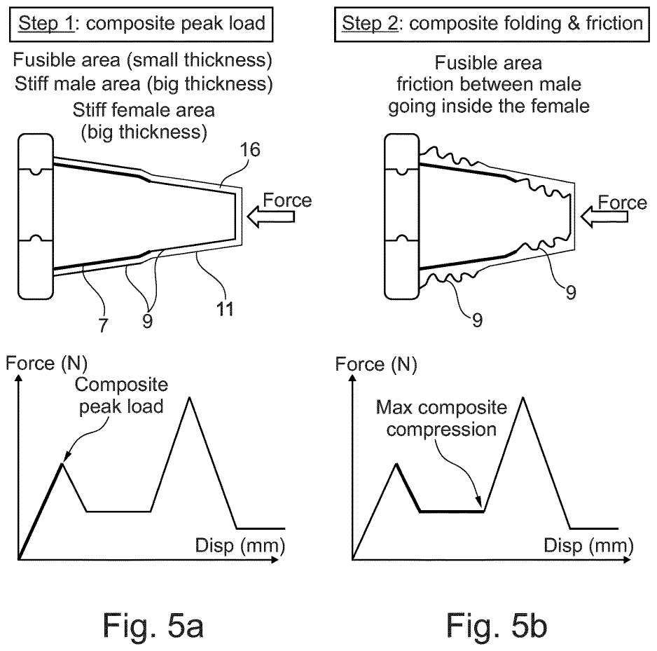

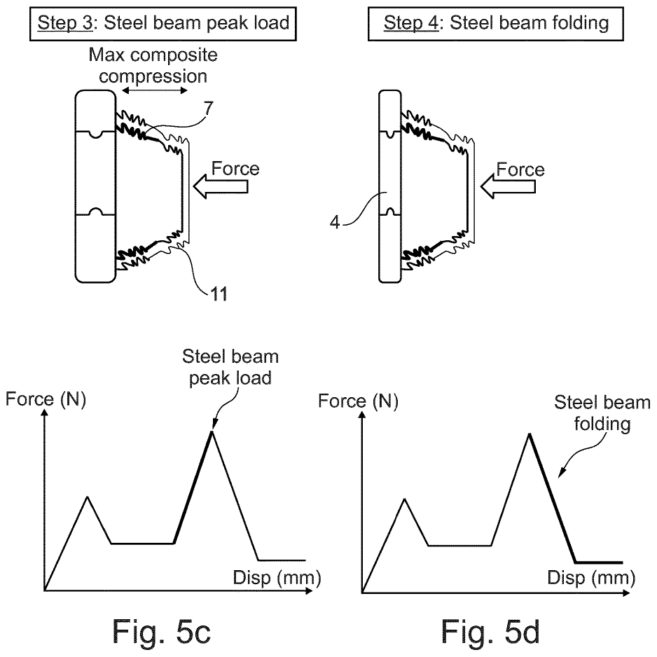

FIGS. 5a-5d Shows the Behavior of the Inventive Member During Impact.

FIG. 1 shows a first embodiment of the inventive member 1, which comprises at least a first layer 2 and a second layer 3. Each layer 2, 3 comprises a multitude of three-dimensional elements 5, which are interconnected, here at a base. The three-dimensional elements are provided in an array, X x Y, here 2 x 15. The member has a length 10, which may be up zo three meters, preferably 1-2 m. Preferably, the two layers are connected to each other, for example by clips to reduce vibration of the layers 2, 3 and hence fatigue and/or noise. In the present case, the member comprises an optional hollow metal structure, preferably an aluminum structure. At least one layer 2, 3 is connected, for example glued to the structure 4. The entire member 1 is preferably inserted into the structure of a vehicle, preferably into a cavity, for example of a rocker. The member improves the impact-resistance of the vehicle structure during an impact. The inventive member is particularly suitable for electric vehicles, particularly to protect their battery.

FIG. 2 depicts the inventive member 1 in the cavity of a vehicle structure 8, for example a rocker. Depicted is a cut perpendicular to the axial extension of the rocker in x-direction. The person skilled in the art understands, that the member 1 need not be placed into a cavity of a vehicle structure 8, even though this embodiment is preferred. The cut shows the two layers 2, 3 each having cone-shaped three-dimensional elements 5. The cone shaped elements of the layer 2 are inserted into the cone shaped three-dimensional elements of the layer 3. Therefore, the three-dimensional elements of layer 2 are the so called “male” three-dimensional elements, while the three-dimensional elements of layer 3 are the so called “female” three-dimensional elements. The male three-dimensional elements are preferably inserted into the female three-dimensional elements to an extend, that their tops and/or their base are in close proximity or even in touch with each other. The three-dimensional elements of one, preferably both layers 2, 3 have an extension 19 in their longest direction, here their height. Preferably, the shape of the cross-section of the three-dimensional elements of one or both layers is a polygon. The shape of the cross section of the three-dimensional elements of at least one layer 2, 3 may change along its height, for example from a hexagon to a quadrangle. Preferably the cross-section of the female three-dimensional elements changes along their height. Prior to an impact, there is preferably a space 16, between the sidewalls 20 of male and female three-dimensional elements 5, which serves as a volume for deformation. The impact direction is exemplary depicted with an arrow 12, which is for example a side impact on the vehicle.

FIG. 3 depicts exemplary details of the three-dimensional elements of the two layers 2, 3. Each three-dimensional elements extends between a base 22 and a top 21. Each three-dimensional elements is hollow and comprises a sidewall 20, which extends around the entire circumference of each three-dimensional element. In the present case, the thickness of the sidewall 20 is not constant over the entire height of the three-dimensional element. The male three-dimensional element has larger wall thickness 7 in the area close to its base, while the wall thickness 9 closer to the top is thinner. Regarding the female three-dimensional elements, the sidewall thickness 11 closer to the top is lager and the sidewall thickness 9 closer to the bottom 9 smaller. The areas of a certain sidewall thickness extend around the entire circumference of the three-dimensional elements and are in the present case separated by a shoulder 17, provided in both three-dimensional elements. The hollow metal structure 4, which is in all embodiments only optional, has here ribs with an indentation.

FIG. 4 shows further details of the male and the female layer 2, 3. It can be seen that the top of the male of three-dimensional elements of layer 2 are inserted into the female three-dimensional elements of layer 3 to an extend that their tops 21 and their base 22 are at least in close proximity, preferably in contact with each other in contacting areas 13. The layer 3 has a stiffer design than layer 2. Therefore, two adjacent three-dimensional elements are, for example, connected by a rib 6. Alternatively of additionally, the three-dimensional elements of layer 3 may be designed such that the sidewall of two adjacent three-dimensional elements touch or is even the same, at least along a certain extent of the height of the three-dimensional elements. The layer 2 is preferably flexible, preferably bendable under its own weight if held at one end. This may be achieved with flexible connecting areas 15 between two adjacent three-dimensional elements. Both layers have preferably planar connecting areas 14, 15, which are after assembly in contact.

The plane in with the three-dimensional elements of a layer 2, 3 are connected may have openings, between two or more, for example four three-dimensional elements. These openings may be bridged by one or more ribs.

FIGS. 5a-5d show the behavior of the inventive member 1 during an impact depicted by an arrow together with a force/displacement-diagram. The force is measured at the left hand side of the metal structure 4. The sidewall design of the three-dimensional elements of the layers is the one as described according to FIG. 3. The sidewall areas with the lower sidewall-thickness are in the present example the so called fusible areas, because they preferably melt during deformation. When the impact starts (Fig, a) the load increases to a peak accompanied by a compression of the structure. As soon as a this peak load has been reached FIG. 5b), the area of the sidewall with the lower sidewall thickness 9, the fusion area, of both three-dimensional elements start to collapse. Each area 9 preferably folds and slides along the adjacent areas 7, 11 with a larger sidewall thickness. As can be seen from the corresponding diagram, the load decreases to a plateau, while the deformation continues. Then (FIG. 5c), the areas with the larger sidewall thickness 7, 11 also collapse, while the areas 9 keep also collapsing, until a totally collapsed state has been reached at the peak load, as can be seen in the accompanying diagram of FIG. 5c. Finally, as depicted in FIG. 5d, the metal structure 4 collapse, preferably by folding of the ribs. This reduces the force on the vehicle parts to be protected to an acceptable level. In case the metal structure is not part of the member 1, the deformation according to FIG. 5d does not take place.

### REFERENCE SIGNS

1 reinforcement member
2 first layer of the composite structure, male structures
3 second layer of the composite structure, female structures
4 hollow metal structure
5 3D-elements
6 Rib, rib to connect female structures
7 area of larger wall thickness, stiffer male area
8 structural member of the vehicle, rocker
9 area of smaller wall thickness area of first deformation, fusible area
10 longitudinal axis, extension in x direction
11 area of larger wall thickness, stiffer female area
12 impact direction
13 contacting area
14 connection 3-D structures female layer, area
15 connection 3-D structures female layer, area
16 volume for deformation between the male and the female structure
17 shoulder, step
18 opening
19 largest extension, height
20 sidewall
21 top of the 3-D elements
22 base of the 3-D elements

1. A member to absorb energy, particularly impact-energy, comprising at least a first layer and a second layer, each layer comprising a multitude of interconnected three-dimensional elements, wherein the three-dimensional elements of the first layer are inserted into the three-dimensional elements of the second layer and/or vice versa, wherein the sidewall of the three-dimensional element of at least one layer has a varying thickness along the largest extension of the three-dimensional elements.

2. The member according to claim 1, wherein the sidewall of the three-dimensional elements of at least one layer has an area of larger wall thickness and an area of smaller wall thickness.

3. The member according to claim 2, wherein the area of larger wall thickness of the three-dimensional elements of one layer is directly adjacent to the area of smaller wall thickness of the three-dimensional elements of an adjacent layer.

4. The member according to claim 2, wherein the areas of different wall thicknesses are separated by a shoulder or an undercut.

5. The member according to claim 2, wherein the three-dimensional elements of each layer are connected by a connecting layer and/or by contacting each other.

6. The member according to claim 5, wherein the connecting layer between two adjacent three-dimensional elements is bendable.

7. The member according to claim 6, wherein the second layer, is stiff, and wherein two adjacent three-dimensional elements are connected by a rib.

8. The member according to claim 6, wherein the first and second layers are connected by a connection means at a top and/or at a base of the three-dimensional elements.

9. The member according to claim 8, wherein the three-dimensional elements of both first and second layers have an opening at the top.

10. The member according to claim 1, wherein the three-dimensional elements are a hollow truncated cone.

11. The member according to claim 8, wherein the shape of a cross section of the three-dimensional elements of at least one layer differs between the cross-section at the base and at the top of three-dimensional elements.

12. The member according to claim 1, wherein prior to an impact, the first and second layers are locally in contact with each other.

13. A system comprising a structure and a member according to claim 1.

14. The system according to claim 13, wherein the structure comprises a cavity in which the member is located.

15. The System according to claim 14, wherein at least one of the first and second layer is attached to the structure.

16. A method to absorb impact energy, with, a member according to claim 1.

17. The method according to claim 16, wherein the three-dimensional elements are expanded and/or compressed and/or tangentially stressed, each reversibly and/or irreversibly.

18. The method according to claim 16, wherein the three-dimensional elements of the first and second layers interlock during their plastic deformation.

19. The member according to claim 1, wherein the second layer is bendable under its own weight when held at one end.

20. The member according to claim 19, wherein each layer is molded as a single element.
